(19) United States
(12) Patent Application Publication
(10) Pub. No.: US 2026/0309126 A1
(43) Pub. Date: Oct. 8, 2026

(54) CONTROL DEVICE FOR A FLAT WIND COLLECTOR

(71) Applicant: KITE DYNAMICS AG, Stuttgart (DE)

(72) Inventors: Felix Christian BARTELS, Stuttgart (DE); Henrik ADORF, Kirchheim unter Teck (DE); Till JUNG, Auerbach (DE)

(21) Appl. No.: 19/636,239

(22) Filed: Apr. 1, 2026

(30) Foreign Application Priority Data
Apr. 3, 2025 (DE) 10 2025 113 178.3

(51) Int. Cl. F03D 7/00

(52) U.S. Cl. CPC F03D 7/051

(57) ABSTRACT

A control device for a planar wind-collecting element including a main drive, a main strand connected to the main drive in a force-transmitting manner, a first secondary strand, and a main distribution unit for coupling the main strand at least to the first secondary strand with a first secondary drive, a first output strand for a first take-off element, a first secondary distribution unit, in which the first secondary strand and a first secondary drive strand connected to the first secondary drive form a first summing gear, the gear output of which is coupled to the first output strand, and a control unit for switching the main drive and/or the first secondary drive to an active and/or inactive state and for setting the rotational speed and the direction of rotation of the main drive and/or the rotational speed and the direction of rotation of the first secondary drive.

### CROSS-REFERENCE

This application claims the benefit of German application DE 10 2025 113 178.3 filed Apr. 3, 2025, which is incorporated herein by reference.

The invention relates to a control device for a planar wind-collecting element, such as an airfoil, a profile, a sail or a kite.

Control devices for kites are known in which one main drive serves four take-off points equally. If the take-off points are ropes or lines, the main drive pays out or reels in the ropes or lines equally in order to determine the flight altitude and orientation of the kite.

Control devices are known from the prior art in which additional actuating means are provided, by means of which the lengths of the ropes or lines can be controlled independently of one another. The ropes or lines are connected to a wind-collecting element, such as a kite, wherein, when four ropes or lines are used, each rope or line actuates a respective attachment point of the kite. In this case, each of the ropes or lines may be connected directly to the kite or indirectly via a control unit arranged below the kite. By varying the lengths of the ropes or lines, the kite can be controlled for collecting wind.

In the known solutions, it has proven disadvantageous that very space-consuming solutions comprising a large number of components are required for this purpose.

### SUMMARY

An object of an embodiment of the invention is to propose a control device for a planar wind-collecting element, such as an airfoil, a profile, a sail or a kite, with which a drive train can be controlled more efficiently.

This object is achieved by a control device for a planar wind-collecting element, such as an airfoil, a profile, a sail or a kite, comprising at least one main drive, at least one main strand connected to the main drive in a force-transmitting manner, at least one first secondary strand, and at least one main distribution unit through which the main strand is coupled at least to the first secondary strand, with at least one first secondary drive, with at least one first output strand for at least one first take-off point, and with at least one first secondary distribution unit, in which the first secondary strand and a first secondary drive strand connected to the first secondary drive in a force-transmitting manner form a first summing gear, the gear output of which is coupled to the first output strand and with at least one control unit by means of which the main drive and/or the first secondary drive can each be switched to an active and/or inactive state, and by means of which at least the rotational speed and the direction of rotation of the main drive and/or the rotational speed and the direction of rotation of the first secondary drive can be adjusted.

By virtue of the control device comprising a main drive and a first secondary drive, the first output strand can be controlled by the main drive and/or by the first secondary drive. As a result, the adjustability of the first output strand by means of two drives is enabled, whereby controllability is improved.

The planar wind-collecting element may be an airfoil, a profile, a sail or a kite.

In the first summing gear, the main drive and the first secondary drive may be coupled to one another with the same direction of rotation or with opposite directions of rotation. If both drives are coupled with the same direction of rotation, the rotational speeds are added together in the direction of the first output strand. If the direction of rotation of the main drive is opposite to the direction of rotation of the first secondary drive, the rotational speeds are subtracted from one another.

The first secondary drive and the main drive can be switched to an active and/or inactive state by the control unit. In this context, this may be understood to mean either merely switching the respective drive on and off, or alternatively coupling and decoupling the respective drive.

Furthermore, it is conceivable that the main drive and/or the first secondary drive each form a motor brake.

In one embodiment of the control device, the control device comprises at least one second output strand for at least one second take-off point arranged in or on the first secondary distribution unit, wherein the first secondary strand and the first secondary drive strand form a second summing gear in the first secondary distribution unit, the gear output of which is coupled to the second output strand.

Since the first secondary distribution unit comprises, in addition to the first summing gear, a second summing gear whose gear output is coupled to the second output strand, two take-off points can be controlled by the main drive and the first secondary drive. As a result, the control device can be configured efficiently.

In a further development of the aforementioned embodiment, it is advantageous if the first secondary strand has, on the input side of the first summing gear of the first secondary distribution unit and on the input side of the second summing gear of the first secondary distribution unit, the same direction of rotation or directions of rotation differing from one another, and/or if the first secondary drive strand has, on the input side of the first summing gear of the first secondary distribution unit and on the input side of the second summing gear of the first secondary distribution unit, the same direction of rotation or directions of rotation differing from one another.

If the first secondary strand has the same direction of rotation on the input side of the first summing gear of the first secondary distribution unit and on the input side of the second summing gear of the first secondary distribution unit, the portion transmitted to the first output strand corresponds to the portion transmitted to the second output strand. If the direction of rotation is opposite, the portions at the first output strand and the portions at the second output strand have opposite signs.

The same applies to the direction of rotation of the first secondary drive strand at the first summing gear and at the second summing gear.

If both the first secondary strand and the first secondary drive strand have the same direction of rotation at the first summing gear, the two incoming portions are added together at the first summing gear. If the directions of rotation are opposite, the two portions are subtracted from one another in the direction of the first output strand.

The same applies to the second summing gear and the second output strand.

Due to the different ways in which the first secondary strand and the first secondary drive strand interact at the first summing gear and/or at the second summing gear, the direction of rotation and the rotational speed transmitted to the first output strand and/or to the second output strand may differ. As a result, different directions of rotation and/or rotational speeds can be set for the individual output strands.

If the take-off points are, for example, ropes or lines, these can thereby be paid out or reeled in at different speeds, or one rope or line can be reeled in while another rope or line is paid out.

In principle, the control device may comprise only the main strand and the first secondary strand. To control additional take-off points, one embodiment of the control device comprises at least one second secondary strand, wherein the main strand is coupled to the second secondary strand by means of the main distribution unit, at least one second secondary drive, at least one third output strand for at least one third take-off point, and at least one second secondary distribution unit in which the second secondary strand and a second secondary drive strand connected to the second secondary drive in a force-transmitting manner form a third summing gear, the gear output of which is coupled to the third output strand, wherein the control unit allows the second secondary drive to be switched to an active and/or inactive state independently of the main drive and of the first secondary drive, and wherein the rotational speed and the direction of rotation of the second secondary drive can be set.

The second secondary distribution unit is constructed analogously to the first secondary distribution unit, wherein the portions of the second secondary strand and of the second secondary drive strand are added together in the summing gear when the directions of rotation are the same and are transmitted at the gear output to the third output strand, and are subtracted from one another when the directions of rotation are opposite.

The second secondary drive can be switched to an active and/or inactive state independently of the main drive and of the first secondary drive. In this case, the second secondary drive can be switched on or off, or coupled into and decoupled from the second secondary drive strand.

In a further development of the aforementioned embodiment, it is advantageous if a fourth output strand for at least one fourth take-off element is provided, which is arranged in or on the second secondary distribution unit, wherein the second secondary strand and the second secondary drive strand form a fourth summing gear in the second secondary distribution unit, the gear output of which is coupled to the fourth output strand.

Since the second secondary distribution unit is coupled to a fourth output strand via the fourth summing gear, two output strands can also be controlled by the second secondary distribution unit.

If the control device comprises a main drive, a first secondary drive and a second secondary drive, by means of which the first output strand, the second output strand, the third output strand and the fourth output strand can be controlled, four take-off elements can be controlled by the control device. If the take-off elements are ropes or lines, these can be reeled in or paid out at different speeds, as described above.

In a further development of the aforementioned embodiment, it is advantageous if the second secondary strand has, on the input side of the third summing gear of the second secondary distribution unit and on the input side of the fourth summing gear of the second secondary distribution unit, the same direction of rotation or directions of rotation differing from one another and/or if the second secondary drive strand has, on the input side of the third summing gear of the second secondary distribution unit and on the input side of the fourth summing gear of the second secondary distribution unit, the same direction of rotation or directions of rotation differing from one another.

This allows the direction of rotation and the rotational speeds at the third output strand and at the fourth output strand to be set.

To couple the first secondary strand and the second secondary strand to the main strand with the same or with different rotational speeds, a further development of the control device comprises at least one main distribution drive associated with the main distribution unit and a first main distribution summing gear formed by the main strand and by a main distribution drive strand connected to the main distribution drive in a force-transmitting manner, the gear output of which is coupled to the first secondary strand, wherein the main distribution drive can be switched to an active and/or inactive state by the control unit and the rotational speed and the direction of rotation of the main distribution drive can be set.

In a further development of the aforementioned embodiment, the control device comprises at least one second main distribution summing gear formed by the main strand and by the main distribution drive strand, the gear output of which is coupled to the second secondary strand.

By providing a first main distribution summing gear and a second main distribution summing gear, the direction of rotation and the rotational speed at the first secondary strand and at the second secondary strand can be set independently of one another.

In a further development of the aforementioned embodiment, it is advantageous if the main strand has, on the input side of the first main distribution summing gear of the main distribution unit and on the input side of the second main distribution summing gear of the main distribution unit, the same direction of rotation or directions of rotation differing from one another, and/or if the main distribution drive strand has, on the input side of the first main distribution summing gear of the main distribution unit and on the input side of the second main distribution summing gear of the main distribution unit, the same direction of rotation or directions of rotation differing from one another.

As a result, the first secondary strand and the second secondary strand can be provided with the same direction of rotation or with different directions of rotation.

The main strand may be implemented in any technically suitable manner, provided that it ensures transmission of a driving force supplied by the main drive towards the secondary strand, in particular the first secondary strand and/or the second secondary strand. In one embodiment of the control device, it is provided that the main strand comprises a first main drive shaft connected to the main drive, which, at an end arranged in the main distribution unit, comprises a first form-fitting and/or force-transmitting section.

In a further development of the control device, it is provided that the main strand comprises at least one second main drive shaft which, in the main distribution unit, comprises a second form-fitting and/or force-transmitting section that engages with the first form-fitting and/or force-transmitting section of the first main drive shaft so as to form a deflection gear, which, at a first end, comprises a first secondary form-fitting and/or force-transmitting section that is coupled in the first main distribution summing gear to the main distribution drive strand, in particular so as to form a deflection gear, and which, at a second end opposite the first end, comprises a second secondary form-fitting and/or force-transmitting section that is coupled in the second main distribution summing gear to the main distribution drive strand, in particular so as to form a deflection gear.

As a result, the main strand comprises the first main drive shaft and the second main drive shaft, wherein the second main drive shaft is connected both to the first main distribution summing gear and to the second main distribution summing gear.

Alternatively, one embodiment of the control device provides that the main strand comprises at least one second main drive shaft which, in the main distribution unit, comprises a second form-fitting and/or force-transmitting section that engages with the first form-fitting and/or force-transmitting section of the first main drive shaft so as to form a deflection gear and which, at a first end, comprises a first secondary form-fitting and/or force-transmitting section that is coupled in the first main distribution summing gear to the main distribution drive strand, in particular so as to form a deflection gear, and that the main strand comprises at least one third main drive shaft which, in the main distribution unit, comprises a third form-fitting and/or force-transmitting section that engages with the first form-fitting and/or force-transmitting section of the first main drive shaft so as to form a deflection gear and which, at a second end, comprises a second secondary form-fitting and/or force-transmitting section that is coupled in the second main distribution summing gear to the main distribution drive strand, in particular so as to form a deflection gear.

In such a case, the main strand, in particular the first main drive shaft, is coupled to two further main drive shafts, namely the second main drive shaft and the third main drive shaft. In this case, the second main drive shaft is associated with the first main distribution summing gear and the third main drive shaft is associated with the second main distribution summing gear.

The first secondary strand may also be implemented in any technically suitable manner, provided that the force transmitted by the main drive via the main strand to the first secondary strand can be transmitted to the first take-off element and/or to the second take-off element. It proves advantageous if the first secondary strand comprises a first first secondary shaft connected to the main distribution unit, which comprises, at an end arranged in the first secondary distribution unit, a first form-fitting and/or force-transmitting section.

Furthermore, one embodiment of the control device provides that the first secondary strand comprises at least one second first secondary shaft which, in the first secondary distribution unit, has a second form-fitting and/or force-transmitting section that engages with the first form-fitting and/or force-transmitting section of the first secondary shaft, in particular so as to form a deflection gear which, at a first end, has a first output form-fitting and/or force-transmitting section that is coupled in the first summing gear to the first secondary drive strand, in particular so as to form a deflection gear, and which, at a second end opposite the first end, has a second output form-fitting and/or force-transmitting section that is coupled in the second summing gear to the first secondary drive strand, in particular so as to form a deflection gear.

In such a case, the first secondary strand comprises only a first secondary shaft and a second secondary shaft, wherein the second secondary shaft forms an input side both in the first summing gear and in the second summing gear. Accordingly, the first secondary strand has the same direction of rotation at the first summing gear and at the second summing gear.

Alternatively, a further development of the control device provides that the first secondary strand comprises at least one second first secondary shaft which, in the first secondary distribution unit, has a second form-fitting and/or force-transmitting section that engages with the first form-fitting and/or force-transmitting section of the first secondary shaft so as to form a deflection gear and which, at a first end, has a first output form-fitting and/or force-transmitting section that is coupled in the first summing gear to the first secondary drive strand, in particular so as to form a deflection gear and that the first secondary strand has at least one third secondary shaft which, in the first secondary distribution unit, has a third form-fitting and/or force-transmitting section that engages with the first form-fitting and/or force-transmitting section of the first secondary shaft, in particular so as to form a deflection gear, and which, at a second end, has a second output form-fitting and/or force-transmitting section that engages in the second summing gear with the first secondary drive strand, in particular so as to form a deflection gear.

By providing a second secondary shaft and a third secondary shaft, the first summing gear and the second summing gear can each be supplied with a respective secondary shaft. As a result, different directions of rotation can be set on the input side of the first summing gear relative to the second summing gear.

The second secondary strand may also be configured in any technically suitable manner, provided that the force transmitted by the main drive can be transmitted to the third take-off element and/or to the fourth take-off element.

It is advantageous if the second secondary strand comprises a first secondary shaft connected to the main distribution unit, which has a first form-fitting and/or force-transmitting section at an end arranged in the second secondary distribution unit.

In a further development, it is advantageous if the second secondary strand comprises at least one second second secondary shaft which, in the second secondary distribution unit, has a second form-fitting and/or force-transmitting section that engages with the first form-fitting and/or force-transmitting section of the first secondary shaft, in particular so as to form a deflection gear, which, at a first end, has a third output form-fitting and/or force-transmitting section that is coupled in the third summing gear to the second secondary drive strand, in particular so as to form a deflection gear, and which, at a second end opposite the first end, has a fourth output form-fitting and/or force-transmitting section that is coupled in the fourth summing gear to the second secondary drive strand, in particular so as to form a deflection gear.

As a result, the same direction of rotation can be set by means of the second second secondary shaft, which enters on the input side of both the third summing gear and the fourth summing gear

To enable different directions of rotation at the third summing gear and at the fourth summing gear, an alternative embodiment of the control device provides that the second secondary strand comprises at least one second secondary shaft which, in the second second secondary distribution unit, has a second form-fitting and/or force-transmitting section that engages with the first form-fitting and/or force-transmitting section of the second secondary strand so as to form a deflection gear, and which, at a first end, has a first output form-fitting and/or force-transmitting section that is coupled in the third summing gear to the second secondary drive strand, in particular so as to form a deflection gear, and that the second secondary strand has at least one third secondary shaft which, in the second secondary distribution unit, has a third form-fitting and/or force-transmitting section that engages with the first form-fitting and/or force-transmitting section of the first secondary shaft, in particular so as to form a deflection gear, and which, at a second end, has a second output form-fitting and/or force-transmitting section that engages in the fourth summing gear with the second secondary drive strand, in particular so as to form a deflection gear.

Furthermore, the main distribution drive strand may also be configured in any technically suitable manner, provided that it fulfils the technical function of coupling the main distribution drive to the first main distribution summing gear and/or to the second main distribution summing gear.

It is advantageous if the main distribution drive strand comprises a first main distribution drive shaft connected to the main distribution drive, which has, at an end arranged in the main distribution unit, a first form-fitting and/or force-transmitting section.

If the same direction of rotation is to prevail at both the first main distribution summing gear and the second main distribution summing gear, it is advantageous if the main distribution drive strand comprises at least one second main distribution drive shaft, which, in the main distribution unit, has a second form-fitting and/or force-transmitting section that engages with the first form-fitting and/or force-transmitting section of the first main distribution drive shaft so as to form a deflection gear, and which, at a first end, has a first secondary form-fitting and/or force-transmitting section that is coupled in the first main distribution summing gear to the main drive strand, in particular so as to form a deflection gear, and which, at a second end opposite the first end, has a second secondary form-fitting and/or force-transmitting section that is coupled in the second main distribution summing gear to the main strand, in particular so as to form a deflection gear.

If different directions of rotation are to be set at the first main distribution summing gear and at the second main distribution summing gear, it is advantageous if the main distribution drive strand comprises at least one second main distribution drive shaft, which, in the main distribution unit, has a second form-fitting and/or force-transmitting section that engages with the first form-fitting and/or force-transmitting section of the first main distribution drive shaft so as to form a deflection gear, and which, at a first end, has a first secondary form-fitting and/or force-transmitting section that is coupled in the first main distribution summing gear to the main distribution drive strand, in particular so as to form a deflection gear, and that the main distribution drive strand has at least one third main distribution drive shaft which, in the main distribution unit, has a third form-fitting and/or force-transmitting section that engages with the first form-fitting and/or force-transmitting section of the first main distribution drive shaft so as to form a deflection gear, and which, at a second end, has a second secondary form-fitting and/or force-transmitting section that is coupled in the second main distribution summing gear to the main strand, in particular so as to form a deflection gear.

Furthermore, in one embodiment of the control device, it is advantageous if the first secondary drive strand comprises a first first secondary drive shaft connected to the first secondary drive, which has, at an end arranged in the first secondary distribution unit, a first form-fitting and/or force-transmitting section.

The direction of rotation at the first summing gear and at the second summing gear may be the same if the first secondary drive strand comprises at least one second first secondary drive shaft which, in the first secondary distribution unit, has a second form-fitting and/or force-transmitting section that engages with the first form-fitting and/or force-transmitting section of the first secondary drive shaft so as to form a deflection gear, which, at a first end, has a form-fitting and/or force-transmitting section that is coupled in the first summing gear to the first secondary strand, in particular so as to form a deflection gear, and which, at a second end, has a form-fitting and/or force-transmitting section that is coupled in the second summing gear to the first secondary strand, in particular so as to form a deflection gear.

Alternatively, the direction of rotation at the first summing gear may differ from the direction of rotation at the second summing gear if the first secondary drive strand comprises at least one second first secondary drive shaft which, in the first secondary distribution unit, has a second form-fitting and/or force-transmitting section that engages with the first form-fitting and/or force-transmitting section of the first secondary drive shaft so as to form a deflection gear, and which, at a first end, has a form-fitting and/or force-transmitting section that is coupled in the first summing gear to the first secondary strand, in particular so as to form a deflection gear, and if the first secondary drive strand has at least one third secondary drive shaft which, in the first secondary distribution unit, has a third form-fitting and/or force-transmitting section that engages with the first form-fitting and/or force-transmitting section of the first secondary drive shaft so as to form a deflection gear and which, at a second end, has a form-fitting and/or force-transmitting section that is coupled in the second summing gear to the first secondary strand, in particular so as to form a deflection gear.

In embodiments of the control device, it is provided that the second secondary drive strand comprises a first secondary drive shaft connected to the second secondary drive, which has, at an end arranged in the second secondary distribution unit, a first form-fitting and/or force-transmitting section.

To obtain the same direction of rotation at the third summing gear and at the fourth summing gear, it is advantageous if the second secondary drive strand comprises at least one second second secondary drive shaft which, in the second secondary distribution unit, comprises a second form-fitting and/or force-transmitting section that engages with the first form-fitting and/or force-transmitting section of the first secondary drive shaft so as to form a deflection gear, which, at a first end, has a form-fitting and/or force-transmitting section that is coupled in the third summing gear to the second secondary strand, in particular so as to form a deflection gear, and which, at a second end, has a form-fitting and/or force-transmitting section that is coupled in the fourth summing gear to the second secondary strand, in particular so as to form a deflection gear.

To set opposite directions of rotation of the second secondary drive strand at the third summing gear and at the fourth summing gear, it is advantageous if the second secondary drive strand comprises at least one second second secondary drive shaft which, in the second secondary distribution unit, has a second form-fitting and/or force-transmitting section that engages with the first form-fitting and/or force-transmitting section of the first secondary drive shaft so as to form a deflection gear, and which, at a first end, has a form-fitting and/or force-transmitting section that is coupled in the third summing gear to the second secondary strand, in particular so as to form a deflection gear, and if the second secondary drive strand has at least one third second secondary drive shaft which, in the first secondary distribution unit, has a third form-fitting and/or force-transmitting section that engages with the first form-fitting and/or force-transmitting section of the first secondary drive shaft so as to form a deflection gear, and which, at a second end, has a form-fitting and/or force-transmitting section that is coupled in the fourth summing gear to the second secondary strand, in particular so as to form a deflection gear.

The form-fitting and/or force-transmitting sections may comprise a gear section, a spur gear section, or the like.

It is advantageous if the first take-off element, the second take-off element, the third take-off element and/or the fourth take-off element comprises a rope retraction and/or rope pay-out device, a rope force amplification device and/or a rope storage device.

As a result, the take-off elements form ropes or lines that can be reeled in or paid out, directly or indirectly, to control the wind-collecting element.

Since at least one summing gear is arranged upstream of each take-off element, each take-off element can be operated at a different rotational speed. As a result, the different ropes or lines can be operated at the same speed or at different speeds. Furthermore, it is also conceivable that all take-off elements, or at least two take-off elements, are paid out or reeled in at the same speed.

Furthermore, it is advantageous if the main drive, the main distribution drive, the first secondary drive and/or the second secondary drive can be operated electrically, magnetically, electromagnetically, mechanically, pneumatically and/or hydraulically.

If one of the drives, in particular the main drive, the main distribution drive, the first secondary drive and/or the second secondary drive, is operated mechanically, this is to be understood as operation by means of combustion power and/or by means of manual force. Manual force may, for example, be understood as muscular force applied by a user of the kite.

Furthermore, it may prove advantageous if the main drive, the main distribution drive, the first secondary drive and/or the second secondary drive comprises an electric generator, in particular a reluctance motor.

In such a case, it is conceivable, for example, to reel in or pay out ropes via the different take-off elements and, in the process, to operate the drives connected via the summing gears, in particular the main drive, the main distribution drive, the first secondary drive and/or the second secondary drive, by the respective paying-out operation, thereby generating electrical energy. In such a case, the drives can also be operated by means of energy recuperation. The drives, in particular the main drive, the main distribution drive, the first secondary drive and/or the second secondary drive, may have a brake, in particular a motor brake, and/or may comprise a parking brake, in particular in the form of a worm.

Furthermore, embodiments are conceivable in which the drives are coupled into and/or decoupled from the different strands.

During recuperative operation, the drives may each act as a brake.

Finally, it is advantageous if the main drive, the main distribution drive, the first secondary drive and/or the second secondary drive each comprise a single drive or is formed by a plurality of drives that are coupled to one another, in particular by means of a gear ring.

In such a case, the individual drives, in particular the main drive, the main distribution drive, the first secondary drive and/or the second secondary drive, may be composed of a plurality of drives. These may, for example, form a gear ring. Furthermore, it is conceivable that, in such a case, a generator can also be coupled in as an additional component.

Further features, details and advantages of the invention will become apparent from the appended patent claims, from the drawings and from the following description of preferred embodiments of the control device.

### BRIEF DESCRIPTION OF THE DRAWINGS

The drawing shows:

FIG. 1 A schematic plan view of an embodiment of the control device;

FIG. 2 A detail view of the control device according to FIG. 1;

FIG. 3 A detail view according to FIG. 2 showing a second embodiment of the control device;

FIG. 4 A perspective detail view of a summing gear of a secondary distribution unit.

### DETAILED DESCRIPTION

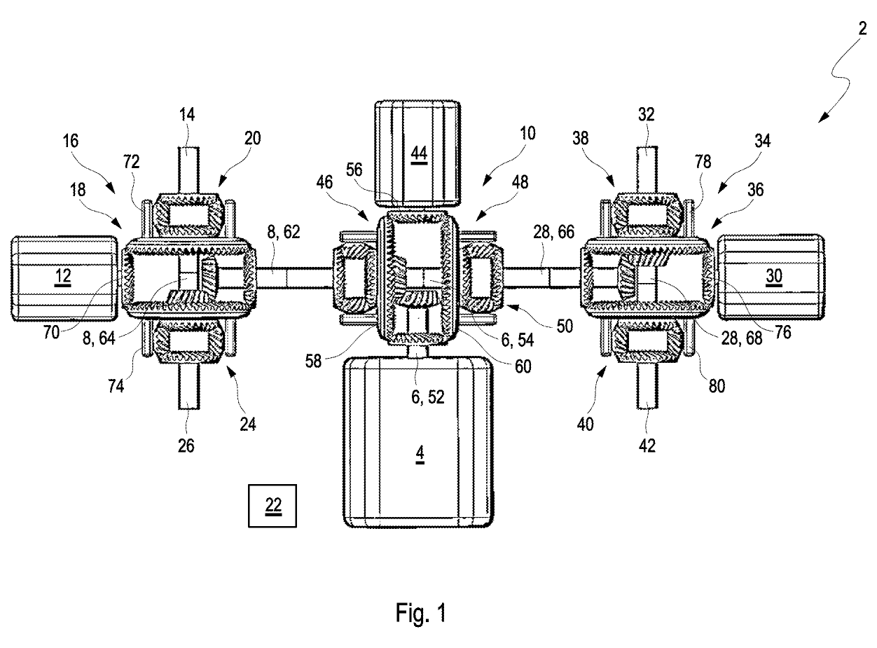

FIG. 1 shows an embodiment of a control device, designated overall by reference 2, for a planar wind-collecting element (not shown in the figures). The wind-collecting element may comprise an airfoil, a profile, a sail or a kite.

The control device 2 comprises a main drive 4 and a main strand 6 connected to the main drive 4 in a force-transmitting manner.

Furthermore, the control device 2 comprises a first secondary strand 8, a main distribution unit 10 by means of which the main strand 6 is coupled at least to the first secondary strand 8, at least one first secondary drive 12, a first output strand 14 for at least one first take-off element, and a first secondary distribution unit 16 in which the first secondary strand 8 and a first secondary drive strand 18 connected to the first secondary drive 12 in a force-transmitting manner form a first summing gear 20. The first output strand 14 is coupled to the gear output of the first summing gear 20.

Furthermore, the control device 2 comprises a control unit 22 by means of which the main drive 4 and/or the first secondary drive 12 can each be switched to an active and/or inactive state and by means of which at least the rotational speed and the direction of rotation of the main drive 4 and/or the rotational speed and the direction of rotation of the first secondary drive 12 can be set.

In the embodiment shown in FIG. 1, the first secondary distribution unit 16 additionally comprises a second summing gear 24, to the gear output of which a second output strand 26 is coupled. A first take-off element and a second take-off element are coupled via the first output strand 14 and the second output strand 26, each of which may comprise, for example, a rope or a line.

Furthermore, the embodiment of the control device 2 according to FIG. 1 comprises a second secondary strand 28 which is coupled to the main strand 6 in the main distribution unit 10.

Furthermore, the control device 2 comprises a second secondary drive 30, a third output strand 32 for a third take-off element, and a second secondary distribution unit 34 in which the second secondary strand 28 and a second secondary drive strand 36 connected to the second secondary drive 30 in a force-transmitting manner form a third summing gear 38. The gear output of the third summing gear 38 is coupled to the third output strand 32.

The second secondary drive 30 can be switched to an active and/or inactive state by the control unit 22 independently of the main drive 4 and of the first secondary drive 12, and the rotational speed and the direction of rotation of the second secondary drive 30 can be set.

In the embodiment shown in FIG. 1, the second secondary distribution unit 34 comprises a fourth summing gear 40, the gear output of which is coupled to a fourth output strand 42 that is connected to a fourth take-off element.

Furthermore, the control device 2 comprises a main distribution drive 44 associated with the main distribution unit 10, by means of which a first main distribution summing gear 46 is formed by the main strand 6 and by a main distribution drive strand 48 connected to the main distribution drive 44 in a force-transmitting manner, the gear output of which is coupled to the first secondary strand 8. The main distribution drive 44 can be switched to an active and/or inactive state by the control unit 22 independently of the other drives, and the rotational speed and the direction of rotation of the main distribution drive 44 can be set.

In the embodiment of the control device 2 shown in FIG. 1, the main distribution unit 10 comprises a second main distribution summing gear 50 formed by the main strand 6 and the main distribution drive strand 48, the gear output of which is coupled to the second secondary strand 28.

In the following, the structure of the control device 2 shown in FIG. 1 will be described in more detail:

The main strand 6 comprises a first main drive shaft 52 connected to the main drive 4. This is connected via a form-fitting and/or force-transmitting section to a second main drive shaft 54 of the main strand 6. The second main drive shaft comprises, at its two mutually opposite ends, in each case a form-fitting and/or force-transmitting section by means of which the second main drive shaft 54 is connected on the input side to the first main distribution summing gear 46 and to the second main distribution summing gear 50. In the embodiment shown in the figures, the second main drive shaft 54 is in this case passed through on both sides by a respective component of the main distribution drive strand 48, wherein the respective form-fitting and/or force-transmitting section is arranged on the side facing the first secondary distribution unit 16 and on the side facing the second secondary distribution unit 34, respectively, and is coupled on the input side to the first main distribution summing gear 46 and to the second main distribution summing gear 50, respectively.

In the present context, the term ‘respectively’ is not to be understood as ‘or’, but rather, in accordance with its original meaning, as ‘and in the other case’.

Furthermore, the main distribution drive strand 48 comprises a first main distribution drive shaft 56 connected to the main distribution drive 44, a second main distribution drive shaft 58 coupled to the first main distribution drive shaft 56 via a form-fitting and/or force-transmitting section, which together with the second main drive shaft 54 forms, on the input side, the first main distribution summing gear 46, as well as a third main distribution drive shaft 60 which, together with the second main drive shaft 54, forms, on the input side, the second main distribution summing gear 50.

The first secondary strand 8 comprises a first first secondary shaft 62 connected to the main distribution unit 10 and a second first secondary shaft 64 connected to the first first secondary shaft 62 via a form-fitting and/or force-transmitting section. This is coupled, via form-fitting and/or force-transmitting sections at its two mutually opposite ends, with the first summing gear 20 and, respectively, with the second summing gear 24.

Correspondingly, the second secondary strand 28 comprises a first secondary shaft 66 connected to the main distribution unit 10 and a second second secondary shaft 68 connected to the first secondary shaft 66 via a form-fitting and/or force-transmitting section. At the second secondary shaft 68, at its respective opposite ends, the second secondary shaft 68 is coupled to the input side of the third summing gear 38 and the fourth summing gear 40, respectively, via a form-fitting and/or force-transmitting section.

The first secondary drive strand 18 comprises a first first secondary drive shaft 70, a second first secondary drive shaft 72 coupled into the first summing gear 20, and a third secondary drive shaft 74 coupled into the second summing gear 24.

The second secondary drive strand 36 comprises a first secondary drive shaft 76 which is connected via a form-fitting and/or force-transmitting section to a second secondary drive shaft 78 coupled into the third summing gear 38, and to a third secondary drive shaft 80 coupled into the fourth summing gear 40.

In the embodiment shown in the figures, the first secondary strand 8 is coupled on the input side into both the first summing gear 20 and the second summing gear 24 with the same direction of rotation. By virtue of the use of three secondary drive shafts 70, 72, 74, the first secondary drive strand 18 is coupled into the first summing gear 20 with a direction of rotation different from the direction of rotation with which it is coupled into the second summing gear 24.

The same applies correspondingly to the second secondary strand 28 and to the second secondary drive strand 36.

By virtue of the configuration at the main distribution unit 10, the same direction of rotation prevails on the input side at both the first main distribution summing gear 46 and the second main distribution summing gear 50 at the main strand 6, in particular at the second main drive shaft 54.

By virtue of the configuration of the main distribution drive 44 with three main distribution drive shafts 56, 58 and 60, the directions of rotation of the main distribution drive strand 48 at the first main distribution summing gear 46 differ from the direction of rotation at the second main distribution summing gear 50.

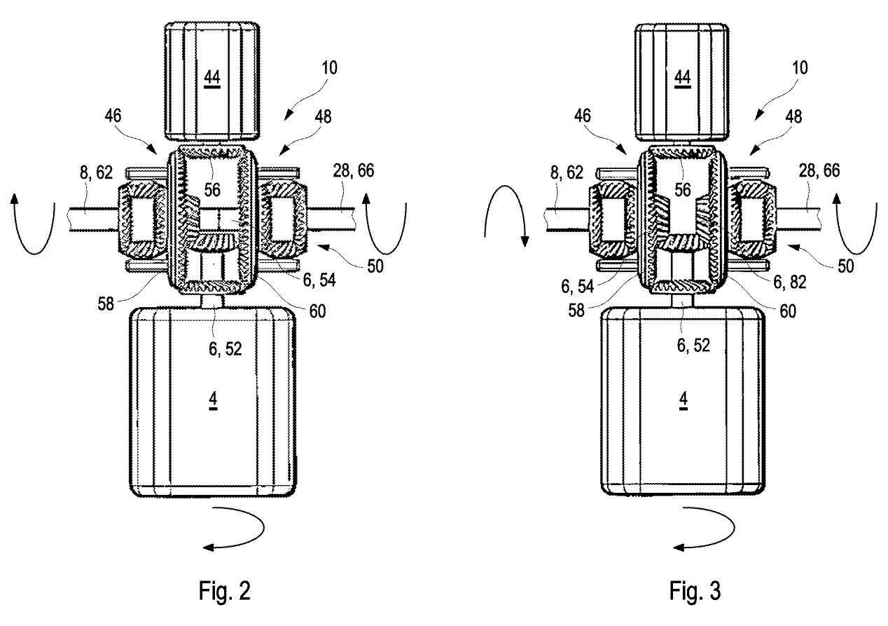

FIG. 2 shows a detail view of the main distribution unit 10 according to the configuration shown in FIG. 1. It can be seen that the direction of rotation transmitted to the first secondary strand 8 via the first main distribution summing gear 46 corresponds to the direction of rotation transmitted to the second secondary strand 28 via the second main distribution summing gear 50.

FIG. 3 shows a second embodiment of the control device 2 in which the main strand 6 comprises a third main drive shaft 82. As a result, the main strand 6 has a different direction of rotation on the input side at the first main distribution summing gear 46 than at the second main distribution summing gear 50.

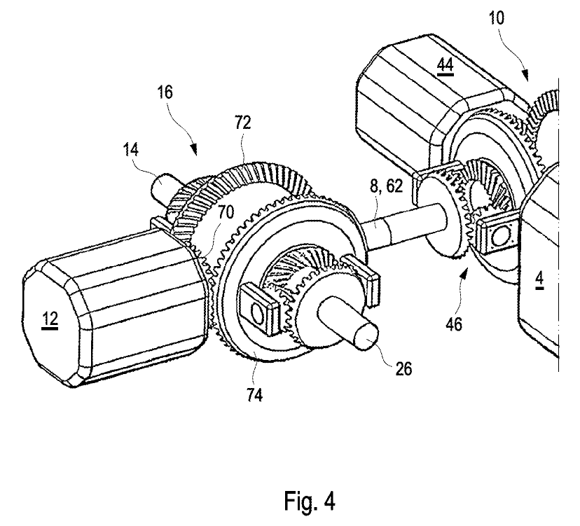

FIG. 4 shows a perspective detail view of the second summing gear 24 in the first secondary distribution unit 16.

### ASPECTS

Any of the aspects can be combined with any other aspect below.

Aspect 1. A control device for a planar wind-collecting element, such as an airfoil, a profile, a sail or a kite, comprising at least one main drive, at least one main strand connected to the main drive in a force-transmitting manner, at least one first secondary strand, and at least one main distribution unit by means of which the main strand is coupled at least to the first secondary strand, with at least one first secondary drive, with at least one first output strand for at least one first take-off element, with at least one first secondary distribution unit, in which the first secondary strand and a first secondary drive strand connected to the first secondary drive in a force-transmitting manner form a first summing gear, the gear output of which is coupled to the first output strand, and with at least one control unit by means of which the main drive and/or the first secondary drive can each be switched to an active and/or inactive state and by means of which at least the rotational speed and the direction of rotation of the main drive and/or the rotational speed and the direction of rotation of the first secondary drive can be set.

Aspect 2. The control device according to Aspect 1, wherein at least one second output strand for at least one second take-off element, which is arranged in or on the first secondary distribution unit, wherein, in the first secondary distribution unit, the first secondary strand and the first secondary drive strand form a second summing gear, the gear output of which is coupled to the second output strand.

Aspect 3. The control device according to Aspect 2, wherein the first secondary strand has, on the input side at the first summing gear of the first secondary distribution unit and at the second summing gear of the first secondary distribution unit, the same direction of rotation or directions of rotation differing from one another and/or that the first secondary drive strand has, on the input side at the first summing gear of the first secondary distribution unit and at the second summing gear of the first secondary distribution unit, the same direction of rotation or directions of rotation differing from one another.

Aspect 4. The control device according to any one of Aspects 1-3, wherein at least one second secondary strand, wherein the main strand is coupled to the second secondary strand via the main distribution unit, with at least one second secondary drive, with at least one third output strand for at least one third take-off element, with at least one second secondary distribution unit, in which the second secondary strand and a second secondary drive strand connected to the second secondary drive in a force-transmitting manner form a third summing gear, the gear output of which is coupled to the third output strand, wherein, by means of the control unit, the second secondary drive can be switched to an active and/or inactive state independently of the main drive and of the first secondary drive, and the rotational speed and the direction of rotation of the second secondary drive can be set.

Aspect 5. The control device according to Aspect 4, wherein at least one fourth output strand for at least one fourth take-off element, which is arranged in or on the second secondary distribution unit, wherein, in the second secondary distribution unit, the second secondary strand and the second secondary drive strand form a fourth summing gear, the gear output of which is coupled to the fourth output strand.

Aspect 6. The control device according to Aspect 5, wherein the second secondary strand has, on the input side at the third summing gear of the second secondary distribution unit and at the fourth summing gear of the second secondary distribution unit, the same direction of rotation or directions of rotation differing from one another and/or that the second secondary drive strand has, on the input side at the third summing gear of the second secondary distribution unit and at the fourth summing gear of the second secondary distribution unit, the same direction of rotation or directions of rotation differing from one another.

Aspect 7. The control device according to any one of Aspects 1-6, wherein at least one main distribution drive associated with the main distribution unit, and by a first main distribution summing gear formed by the main strand and by a main distribution drive strand connected to the main distribution drive in a force-transmitting manner, the gear output of which is coupled to the first secondary strand, wherein, by means of the control unit, the main distribution drive can be switched to an active and/or inactive state and the rotational speed and the direction of rotation of the main distribution drive can be set.

Aspect 8. The control device according to Aspect 7, wherein at least one second main distribution summing gear formed by the main strand and the main distribution drive strand, the gear output of which is coupled to the second secondary strand.

Aspect 9. The control device according to Aspect 8, wherein the main strand has, on the input side at the first main distribution summing gear of the main distribution unit and at the second main distribution summing gear of the main distribution unit, the same direction of rotation or directions of rotation differing from one another and/or that the main distribution drive strand has, on the input side at the first main distribution summing gear of the main distribution unit and at the second main distribution summing gear of the main distribution unit, the same direction of rotation or directions of rotation differing from one another.

Aspect 10. The control device according to any one of Aspects 1-9, wherein the first take-off element, the second take-off element, the third take-off element and/or the fourth take-off element comprise a rope retraction and/or rope pay-out device, a rope force amplification device and/or a rope storage device.

Aspect 11. The control device according to any one of Aspects 1-10, wherein the main drive, the main distribution drive, the first secondary drive and/or the second secondary drive are operable electrically, magnetically, electromagnetically, mechanically, pneumatically and/or hydraulically.

Aspect 12. The control device according to any one of Aspects 1-11, wherein the main drive, the main distribution drive, the first secondary drive and/or the second secondary drive comprise an electric generator, in particular a reluctance motor.

Aspect 13. The control device according to any one of Aspects 1-12, wherein the main drive, the main distribution drive, the first secondary drive and/or the second secondary drive each comprise a single drive or are formed by a plurality of drives which are coupled to one another, in particular by means of a gear ring.

The features of the invention disclosed in the above description, in the claims and in the drawing may be essential for the realisation of the invention in its various embodiments, both individually and in any combination, within the scope of protection of the following claims.

### REFERENCE SYMBOL LIST

2 Control device

4 Main drive

6 Main strand

8 First secondary strand

10 Main distribution unit

12 First secondary drive

14 First output strand

16 First secondary distribution unit

18 First secondary drive strand

20 First summing gear

22 Control unit

24 Second summing gear

26 Second output strand

28 Second secondary strand

30 Second secondary drive

32 Third output strand

34 Second secondary distribution unit

36 Second secondary drive strand

38 Third summing gear

40 Fourth summing gear

42 Fourth output strand

44 Main distribution drive

46 First main distribution summing gear

48 Main distribution drive strand

50 Second main distribution summing gear

52 First main drive shaft

54 Second main drive shaft

56 First main distribution drive shaft

58 Second main distribution drive shaft

60 Third main distribution drive shaft

62 First first secondary shaft

64 Second first secondary shaft

66 First second secondary shaft

68 Second second secondary shaft

70 First first secondary drive shaft

72 Second first secondary drive shaft

74 Third first secondary drive shaft

76 First second secondary drive shaft

78 Second second secondary drive shaft

80 Third second secondary drive shaft

82 Third main drive shaft

1. A control device for a planar wind-collecting element comprising:
at least one main drive,
at least one main strand connected to the main drive in a force-transmitting manner,
at least one first secondary strand, and
at least one main distribution unit by means of which the main strand is coupled at least to the first secondary strand,
with at least one first secondary drive,
with at least one first output strand for at least one first take-off element,
with at least one first secondary distribution unit,
in which the first secondary strand and a first secondary drive strand connected to the first secondary drive in a force-transmitting manner form a first summing gear, the gear output of which is coupled to the first output strand, and
with at least one control unit by means of which the main drive and/or the first secondary drive can each be switched to an active and/or inactive state and by means of which at least the rotational speed and the direction of rotation of the main drive and/or the rotational speed and the direction of rotation of the first secondary drive can be set,
wherein at least one second output strand for at least one second take-off element, which is arranged in or on the first secondary distribution unit, wherein, in the first secondary distribution unit, the first secondary strand and the first secondary drive strand form a second summing gear, the gear output of which is coupled to the second output strand.

2. The control device according to claim 1, wherein the first secondary strand has, on the input side at the first summing gear of the first secondary distribution unit and at the second summing gear of the first secondary distribution unit, the same direction of rotation or directions of rotation differing from one another and/or that the first secondary drive strand has, on the input side at the first summing gear of the first secondary distribution unit and at the second summing gear of the first secondary distribution unit, the same direction of rotation or directions of rotation differing from one another.

3. The control device according to claim 1, wherein at least one second secondary strand, wherein the main strand is coupled to the second secondary strand via the main distribution unit, with at least one second secondary drive, with at least one third output strand for at least one third take-off element, with at least one second secondary distribution unit, in which the second secondary strand and a second secondary drive strand connected to the second secondary drive in a force-transmitting manner form a third summing gear, the gear output of which is coupled to the third output strand, wherein, by means of the control unit, the second secondary drive can be switched to an active and/or inactive state independently of the main drive and of the first secondary drive, and the rotational speed and the direction of rotation of the second secondary drive can be set.

4. The control device according to claim 3, wherein at least one fourth output strand for at least one fourth take-off element, which is arranged in or on the second secondary distribution unit, wherein, in the second secondary distribution unit, the second secondary strand and the second secondary drive strand form a fourth summing gear, the gear output of which is coupled to the fourth output strand.

5. The control device according to claim 4, wherein the second secondary strand has, on the input side at the third summing gear of the second secondary distribution unit and at the fourth summing gear of the second secondary distribution unit, the same direction of rotation or directions of rotation differing from one another and/or that the second secondary drive strand has, on the input side at the third summing gear of the second secondary distribution unit and at the fourth summing gear of the second secondary distribution unit, the same direction of rotation or directions of rotation differing from one another.

6. The control device according to claim 1, wherein at least one main distribution drive associated with the main distribution unit, and by a first main distribution summing gear formed by the main strand and by a main distribution drive strand connected to the main distribution drive in a force-transmitting manner, the gear output of which is coupled to the first secondary strand, wherein, by means of the control unit, the main distribution drive can be switched to an active and/or inactive state and the rotational speed and the direction of rotation of the main distribution drive can be set.

7. The control device according to claim 6, wherein at least one second main distribution summing gear formed by the main strand and the main distribution drive strand, the gear output of which is coupled to the second secondary strand.

8. The control device according to claim 7, wherein the main strand has, on the input side at the first main distribution summing gear of the main distribution unit and at the second main distribution summing gear of the main distribution unit, the same direction of rotation or directions of rotation differing from one another and/or that the main distribution drive strand has, on the input side at the first main distribution summing gear of the main distribution unit and at the second main distribution summing gear of the main distribution unit, the same direction of rotation or directions of rotation differing from one another.

9. The control device according to claim 1, wherein the first take-off element, the second take-off element, the third take-off element and/or the fourth take-off element comprise a rope retraction and/or rope pay-out device, a rope force amplification device and/or a rope storage device.

10. The control device according to claim 1, wherein the main drive, the main distribution drive, the first secondary drive and/or the second secondary drive are operable electrically, magnetically, electromagnetically, mechanically, pneumatically and/or hydraulically.

11. The control device according to claim 1, wherein the main drive, the main distribution drive, the first secondary drive and/or the second secondary drive comprise an electric generator.

12. The control device according to claim 1, wherein the main drive, the main distribution drive, the first secondary drive and/or the second secondary drive each comprise a single drive or are formed by a plurality of drives which are coupled to one another.
